(19) United States
(12) Patent Application Publication
(10) Pub. No.: US 2025/0061100 A1
(43) Pub. Date: Feb. 20, 2025

(54) SYSTEMS AND METHODS FOR GENERATING AND USING A UNIVERSAL DATASET

(71) Applicant: JPMORGAN CHASE BANK, N.A., New York, NY (US)

(72) Inventors: Hardik DARJI, Colonia, NJ (US); Ross DEMARCO, Oradell, NJ (US); Jiemin YU, Edgewater, NJ (US); Rosa M. RITA, Pelham, NY (US); Jeremy R. GELLER, Roslyn, NY (US); David V. SAPUPPO, Old Bethpage, NY (US); Erin E. SCHULER, New York, NY (US)

(21) Appl. No.: 18/807,531

(22) Filed: Aug. 16, 2024

Related U.S. Application Data
(60) Provisional application No. 63/520,428, filed on Aug. 18, 2023.

(51) Int. Cl. G06F 16/215; G06F 16/22; G06F 16/23

(52) U.S. Cl. CPC G06F 16/215; G06F 16/2228; G06F 16/2365

(57) ABSTRACT

The techniques described herein relate to a method including: executing a self-deduplication process on a first dataset and a second dataset; standardizing the first dataset and the second dataset using a common data model; indexing records from the first dataset and the second dataset in a common index; scoring records in the common index; deduplicating the records in the common index; and storing the records in the common index as a master dataset.

### RELATED APPLICATIONS

This application claims the benefit of U.S. Provisional Patent Application Ser. No. 63/520,428, filed Aug. 18, 2023. The disclosure of this application is hereby incorporated, by reference, in its entirety.

### BACKGROUND

### 1. Field of the Invention

This disclosure generally relates to systems and methods for generating and using a universal dataset.

### 2. Description of the Related Art

People and company related information is key to many businesses. Various data sources are available with this information. Technical challenges arise, however, when designing a system to match one data source to another data source accurately. This is due not only to the size of respective data sources, but also to duplicate data that can prove difficult to find and eliminate. Accuracy is defined as one entity is matched to the same entity from both the datasets. Accurate matching, however, is important in obtaining meaningful information that can be used on downstream processes and for training, validating, and providing as input to machine learning (ML) models.

Conventionally, multiple data sources are matched one by one with each other. Then a deduplication step is performed to obtain a final data source. In contrast, embodiments of the present disclosure may provide a process whereby a first data source is matched with other data sources iteratively. This approach negates a deduplication procedure at each matching procedure and creates a robust final output.

Person matching (i.e., matching disparate records in different data sources where the disparate records represent the same person) has proven to be challenging across various data sources and various data formats. Nevertheless, obtaining correct matches between data sources is important since this information may be used by organizations for deepening existing client relationships and for new client acquisition. As such, there is a need for a process to match multiple data sources and obtain an output containing matched and unmatched results.

### SUMMARY

Systems and methods for generating and using a universal dataset are disclosed. In some embodiments, the techniques described herein relate to a method including: executing a self-deduplication process on a first dataset and a second dataset; standardizing the first dataset and the second dataset using a common data model; indexing records from the first dataset and the second dataset in a common index; scoring records in the common index; deduplicating the records in the common index; and storing the records in the common index as a master dataset.

In some embodiments, the techniques described herein relate to systems and methods including one or more processors that execute instructions, for example stored on a memory, including steps of executing a self-deduplication process on a first dataset and a second dataset; standardizing the first dataset and the second dataset using a common data model; indexing records from the first dataset and the second dataset in a common index; scoring records in the common index; deduplicating the records in the common index; and storing the records in the common index as a master dataset.

According to some embodiments, the instruction may further comprise pairing partial matches from the first dataset and the second dataset. According to some embodiments, the instruction may further comprise calculating a frequency for one or more of a phone number, an address, and a company name for each dataset, and retaining matching pairs based on the frequency being less than a threshold. According to some embodiments, the instruction may further comprise appending each potential matching pair to the master dataset based on a frequency less than a threshold of a type of information. According to some embodiments, the instruction may further comprise generating a score with a point value for a matched pair from each dataset, and retaining matching pairs based on the point value at least meeting a threshold amount. According to some embodiments, the instruction may further comprise generating a final score table with the indexed records and the scores, wherein deduplicating comprises sorting the final score table in ascending order a generated first unique identification of the common index, sorting in descending order a generated second unique identification of the common index, sorting a score in a descending order, and retaining only a first row of the table per first unique identification.

According to some embodiments, the instruction may further comprise deduplicating further comprises sorting the final score table in ascending order a generated first unique identification of the common index, sorting in ascending order a generated second unique identification of the common index, sorting a score in a descending order, and retaining only final scores for the generated second unique identification.

In some embodiments, the techniques described herein relate to systems and methods including one or more processors that execute instructions including steps of matching a first dataset from an internal dataset from a memory on a computer network with a second dataset from an external dataset and forming a larger dataset from the first dataset and the second dataset; de-duplicating the larger dataset; identifying a subset from the larger dataset using a parameter; determining associated features of the subset; prioritizing the associated features based on a detail of the first or second datasets; identifying known features in a local database based on the prioritized associated features and estimating a strength of connection of the known features and the prioritized associated features; selecting an internal database based on the known features, the associated features, and a score of the associated and known features as a match with the internal database; and generating an interface comprising a message based on the known features, the internal database, and the associated features.

### BRIEF DESCRIPTION OF THE DRAWINGS

FIG. 1 illustrates a process of master dataset creation and application according to an embodiment;

FIG. 2a illustrates a process of data preparation according to an embodiment;

FIG. 2b illustrates a process of scoring and matching datasets according to an embodiment;

FIG. 3 illustrates a process of indexing datasets according to an embodiment;

FIG. 4 illustrates a scoring process and exemplary point values and score thresholds according to an embodiment;

FIG. 5 illustrates a deduplication cleaning process according to an embodiment;

FIG. 6 illustrates a self-deduplication cleaning process according to an embodiment;

FIG. 7 illustrates a deduplication cleaning process according to an embodiment;

FIG. 8 illustrates a data curation and appending process according to an embodiment;

FIG. 9 illustrates a wealth scoring process according to an embodiment;

FIG. 10 illustrates a location prioritization process according to an embodiment;

FIG. 11 illustrates a known associate identification process according to an embodiment;

FIG. 12 illustrates a process of creating a master dataset according to an embodiment;

FIG. 13a illustrates a contact timing process according to an embodiment;

FIG. 13b illustrates a contact timing process according to an embodiment;

FIG. 14 illustrates an advisor matching process according to an embodiment;

FIG. 15 illustrates an automated contact process according to an embodiment; and

FIG. 16 illustrates a block diagram of a computing device according to an embodiment.

### DETAILED DESCRIPTION

Systems and methods for generating and using a universal dataset are disclosed.

While aspects of this disclosure may contemplate person matching across datasets as a use case, such a use case is merely exemplary, and the techniques described herein may be used to match any fields across datasets.

In accordance with embodiments disclosed herein, data sources for matching may be any number of data sources and may be either public or private. Organizations, particularly enterprise organizations, often have many robust datasets that may be matched and deduplicated, and the results of which may form a master dataset. For instance, a large financial institution may maintain several internal datasets and may have access to several external datasets. Datasets may include information such as personal information, professional information, financial information, and mortgage and other loan information.

In accordance with embodiments disclosed herein, a matching algorithm may use an iterative technique to match multiple data sources and obtain a final output containing a matched/unmatched master table in a master dataset. A master dataset may have a data model that includes a number of default fields. Data model fields may include fields such as “Person,” “Email,” “Phone Number,” “Address,” “Company,” and any other necessary or desirable fields.

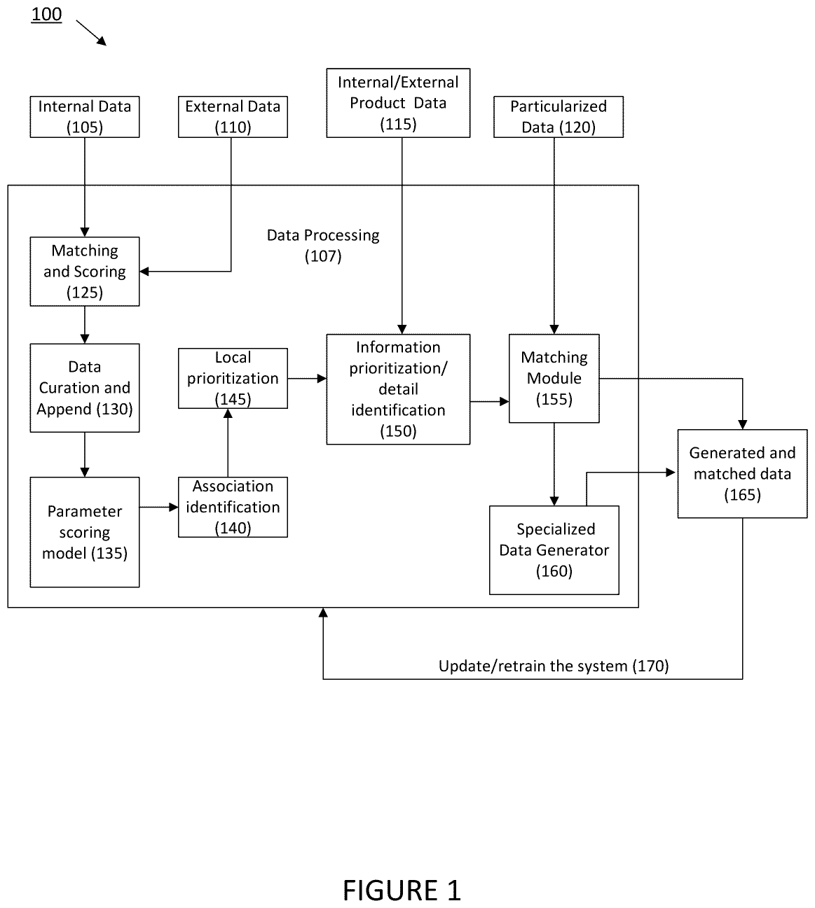

FIG. 1 illustrates a process 100 of creating and applying master datasets according to some embodiments. Process 100 may be used to generate and apply specialized data based on matched data. Depending on the implementation, process 100 may be in the form of instructions executed by a processor.

In some embodiments, internal data 105 and/or external data 110 may be received from one or more original sources. Internal data 105 may be available within a network of an organization, whereas external data 110 may be available through public sources, available from online repositories, and/or a result of one or more surveys.

A matching and scoring module 125 may be configured to receive a dataset and/or generate a dataset from two sets of data, such as from the internal data 105 and/or external data 110. In some embodiments, the matching and scoring module 125 may utilize machine learning (ML) to generate a resulting dataset. The resulting dataset may be considered a Universal Persons' Dataset where a list of persons and associated pertinent features may be stored therein.

The resulting dataset from matching and scoring module 125 may be sent to a curating and appending module 130, which may curate data from internal and external data sources (e.g., data may be curated from one or more of the datasets used to produce a master dataset). Curated data may include useful data that is not included in a data model for a master dataset (e.g., a Universal Persons' Dataset). In some embodiments, pertinent data features may be appended to the master dataset.

Next, a parameter scoring module 135 may be configured to calculate a key parameter score and may identify a key parameter for one or more records of the master dataset. In some embodiments, the key parameter score may be a wealth score. The key parameter score may be a numerical value. For example, the identified parameter may be a source of wealth such as from related businesses, property, or the likes. Parameter scoring module 135 can apply a threshold to the key parameter scores of the records based on one or more measures. The measure may be a measure of wealth, a location, an age, and/or an event associated with the individual (e.g., a home or employment change).

An association identification module 140 may be configured to determine one or more associates (e.g., acquaintances, business partners/colleagues, family) connected to an individual based on the internal data 105 and/or external data 110 using the master dataset. Association identification module 140 may output an estimate of a strength of a connection of the associates to the individual. In some embodiments, the reasoning for how the associates know the individual may also be identified.

Thereafter, a local prioritization module 145 may be configured to determine a common location, an office location, market area, and/or other geographic locations for the individual and/or the associates using the master dataset from association identification 140.

An information prioritization/detail identification module 150 may be configured to identify a reason (e.g., based on the event), a time, and/or a method of communication (e.g., call, email, through the identified associate) to contact the individual using the location extracted from the local prioritization module 145 and certain internal and/or external product data 115. Internal/external product data 115 may include, for example, a listing of products or services. In some embodiments, information prioritization/detail identification module 150 may further be configured to identify personalized words using one or more large language models, as described below. The personalized words may be based on the listing of products or services, the reason/event, the common location and/or the office location or market area, the connection between the associates and the individual, and/or the identification of associates.

A matching module 155 may be configured to match the individual with an advisor (e.g., financial advisor) based on similarities using the reason, time, and/or method of communication identified by information prioritization/detail identification module 150 and particularized data 120 such as a list of advisors and each advisor may have an advisor profile with details of the advisor from a database. The similarities may be identified based on the advisor profile and relevant details (e.g., location, business interest, recreational interest, known associates). In some embodiments, the advisor may use the Universal Persons' Dataset to search for likely prospects based on one or more criteria.

A specialized data generator 160 may be configured to generate specialized data based on the output of matching module 155 and detail identification module 150. The specialized data generated by the specialized data generator 160 may be an email or a text to be provided via a user interface. The email or text may include details of the advisor, the event, products or services, the reason/event, the common location and/or the office location or market area, the connection between the associates and the individual, and/or the identification of associates. The email or text may be generated using a large language model, which may be a part of specialized data generator 160 and discussed in greater detail below. Based on the outputs of specialized data generator 160 and matching module 155, generated and matched data 165 may be extrapolated. For example, the communication, email, and/or message through a user interface may be sent over a network to the identified individual.

In some embodiments, generated and matched data 165, feedback, or a response to the resulting generated and matched data 165 from an advisor or the individual, may be used to update/retrain 170 one or more models of process 100.

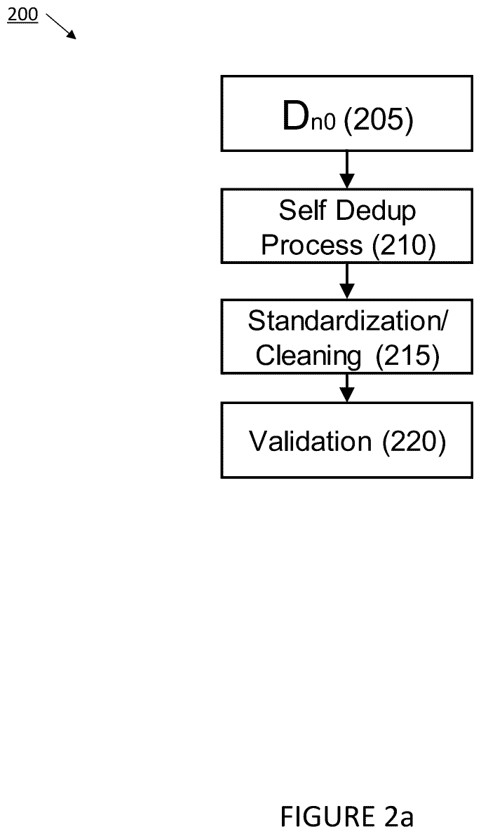

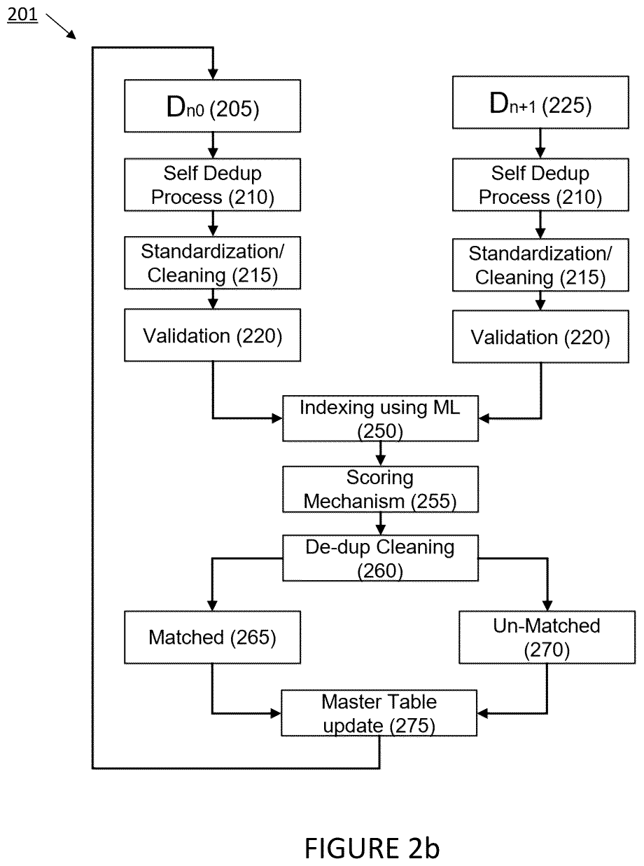

FIG. 2a illustrates a preparatory process 200 according to some embodiments. Depending on the implementation, the process 200 may be in the form of instructions executed by a processor.

In step 205, a first dataset may be received for further processing. The first dataset may be stored on a database stored on a memory as part of a computer network, on a cloud, or a server. In some embodiments, the first dataset may be a Universal Persons' Dataset and/or a table. Depending on the embodiments, the first dataset may be received from an original source.

In step 210, duplicate records from the first dataset may be deduplicated by a self-deduplication process. In embodiments, the self-deduplication process may remove duplicate records within the first dataset. Step 210 may also include parsing the data of the first dataset into a data model. The data model can include data fields that track various types of record details (e.g., name, email, phone, address, or company). Record details may make up an individual record.

In step 215, the data within the first dataset may be standardized and/or cleaned. For example, rules may be applied to the data within the first dataset to, for example, remove extra spaces or otherwise match formatting of the second dataset record details to those of the first dataset.

In embodiments, this may also include fitting data of the respective datasets into known expressions (e.g., a standard number of characters, a position of the characters) or an expected format of known expressions to standardize data into one or more expected formats.

In step 210, the data within the first dataset may be validated to have been standardized. Any data that does not fit one or more expected formats can be iteratively processed and/or isolated.

FIG. 2b illustrates a process 201 of a scoring and matching process according to some embodiments. Depending on the implementation, the process 201 may be in the form of instructions executed by a processor.

Steps 205, 210, 215, and 220 may be similar to those described in FIG. 2a. A similar process may be applied to a second dataset (i.e., Dₙ₊₁). In some embodiments, the first dataset may be received as a version of a master table or Universal Persons' Dataset from step 275. Once the data within the first dataset and the second dataset have undergone the preprocessing process, which may be optional. In step 250, the validated data may be indexed to create indices for potentially matching pairs and to identify a list of indexed potential pairs. In some embodiments, machine learning may be used to identify the list of indexed potential pairs.

For example, step 250 may include using a machine learning model to create potential matching pairs of records based on a record detail match, where the record detail can include, for example, a first and a last name. For instance, John Doe from the first dataset may be matched and paired with John Doe from the second dataset. The standardization from step 215 allows matches to be identified despite differences in the datasets (e.g., a record of a date of 1966 Oct. 1 can be matched to Oct. 10, 1966). Similarly, individual names, emails, phone numbers, addresses, and company names may be matched. In some embodiments, an elastic search may be utilized to pair partial matches in the first dataset and the second dataset (e.g., John Doe from the first dataset may be paired with Jon Doe from the second dataset). The resulting table index of matching pairs may be scored in step 255.

In step 255, the potential pairs from step 250 may be scored based on a matching of record details. The potential pairs with more than a threshold score may be kept as identified pairs and the remaining potential pairs with less than a threshold score can be left as separate, unique records. The output of step 255 may be a table of identified pairs and unmatched records (e.g., separate, unique records).

In step 260, deduplication and/or cleaning may be performed on the list of identified pairs and the unmatched records to eliminate duplicates. The output of step 260 may be a master table.

Records from the first dataset and the second datasets may either be matched 265 or unmatched 270. In step 275, the matched records and/or the unmatched records may be indicated accordingly in the master table. The master table may be used as the first dataset in a subsequent iteration together with a new second dataset. As can be appreciated, if the master table was previously created, at a subsequent step 275, the master table may be updated instead of being created anew.

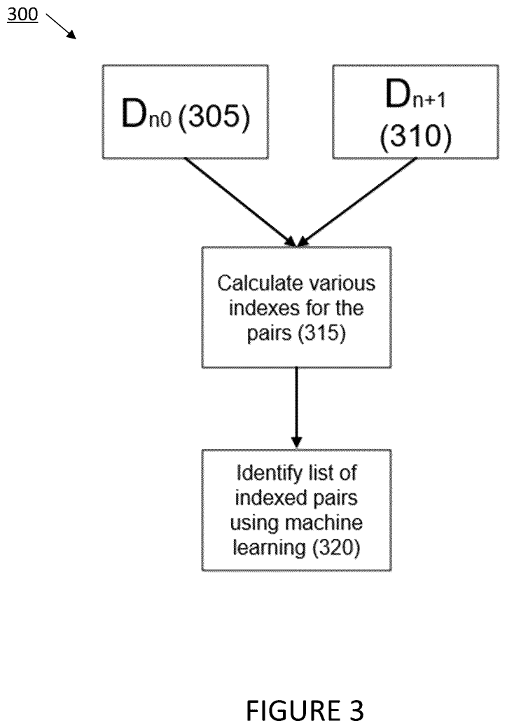

FIG. 3 illustrates an indexing process 300 according to some embodiments. Depending on the implementation, the process 300 may be in the form of instructions executed by a processor.

In step 305, a first dataset (Dₙ₀) may be received, an in step 310, a second dataset Dₙ₊₁) may be received. The first dataset and the second dataset may be accessed or retrieved from a database stored on a memory as part of a computer network, on a cloud, or a server. In some embodiments, the first dataset can be received as a version of a master table or Universal Persons' Dataset.

At step 315, indices can be created for potentially matching pairs from the first dataset and the second dataset. For example, step 315 may include calculating various indices for potentially matching pairs. The index may include a likelihood that two similar records are the same record. For instance, step 315 may include calculating whether John Doe from the first dataset may be matched and paired with John Doe from the second dataset based on one or more criteria. Examples of the criteria may include a number of the same or similar characters, a number of characters, a matching first, middle, and/or last name, a match of an email address, address, or other information associated with the record.

Step 315 may also include creating different indices for different types of information reflected in the potentially matching pairs. For example, a first index can be created based on name matching (e.g., either a first and last name, a first and middle name). Elastic searching can be used to create a larger number of potentially matching pairs. Then, a second index can be created based on email matching (e.g., two emails that are the same or similar). Then, a third index can be created based on phone number matching (e.g., two phone numbers that are the same or similar). The same can occur for other record details such as a company address, a date of birth, a physical address, a company name, subsets of certain record details (e.g., for an address, the zip code or state), and any other record details associated with the individual in the datasets.

In some embodiments, a frequency of occurrence may be calculated for a record detail such as a phone number, address, and/or company name in the first dataset and the second dataset. Records associated with the record details of frequency less than a threshold (e.g., five) can be kept. A potentially matching pair can then be created from the records with the low frequency record details.

The threshold may be set based on historical data or may be manually set.

In step 320, a list of indexed potential pairs may be identified. In some embodiments, machine learning may be used to prepare the list of indexed potential pairs. The use of machine learning allows for quick processing of large numbers (e.g., thousands) of indexed potential pairs. The ML model can be trained on previous good or bad index pairs considering various data points as input including the frequency and matching attributes of record details. This training data can be verified by users. Then the model may be provided the indexing dataset to identify good matching pairs that would have high likelihood of being matched together. This way, a classification ML model would identify potential accurate matches quicker and speed up the matching process.

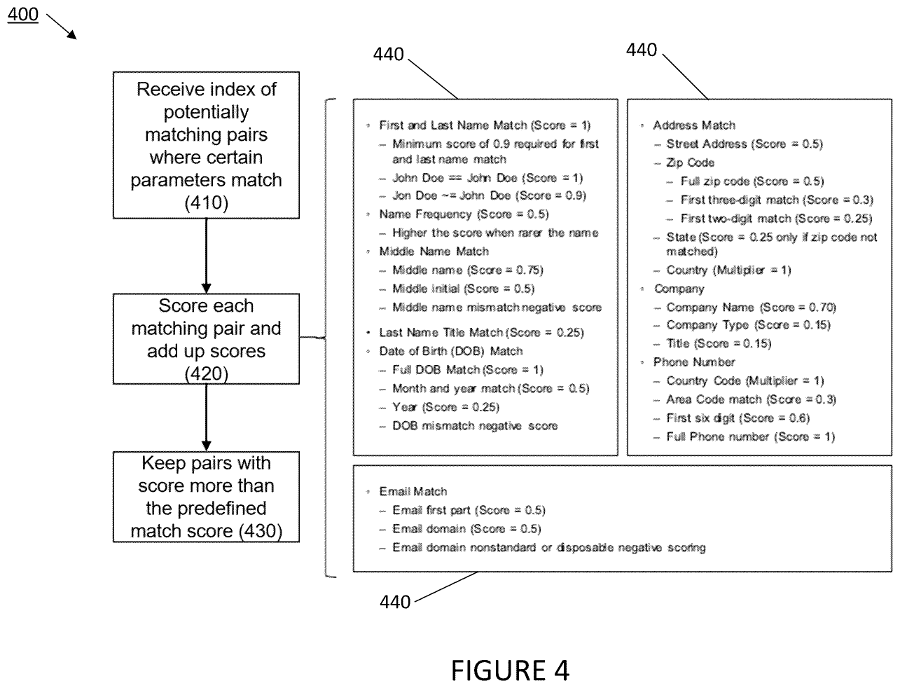

FIG. 4 illustrates a scoring process 400 and some exemplary point values and score thresholds according to certain embodiments. Depending on the implementation, the process 400 may be in the form of instructions executed by a processor.

In step 410, an index of potentially matching pairs based on where certain record details match may be received. For example, step 410 may receive the index from step 320.

In step 420, each potentially matching pair of records may be scored, and the scores for each potentially matching pair may be aggregated. This may be based on all available record details for the pair of records. For example, as illustrated in exemplary boxes 440, data fields for certain record details may be assigned point values and ranges and matching fields from a first and a second dataset may have an assigned point value within the range that, when calculated, is added to a potentially matching pair's score. A variety of data fields and scores may be used and assigned as is necessary and/or desired, and are not limited to the examples shown in boxes 440. A minimum point value required for retention may be defined and all pairs with a total score that is over a threshold amount may be retained as a match.

In step 430, pairs with scores more than the predefined match score may be retained. Records associated with the pairs that are kept may be deduplicated to reduce future processing and overlap and/or information from the records in the datasets can be combined to fill in missing data fields. Pairs that do not meet this threshold may be discarded. The associated records can be kept in the master dataset as separate, unique records. In some embodiments, a record of the failure to match the two records from the datasets can be recorded to avoid the exact same analysis in future iterations. In some embodiments, the record of the failure to match can be reflected in a unique identification assigned to the record.

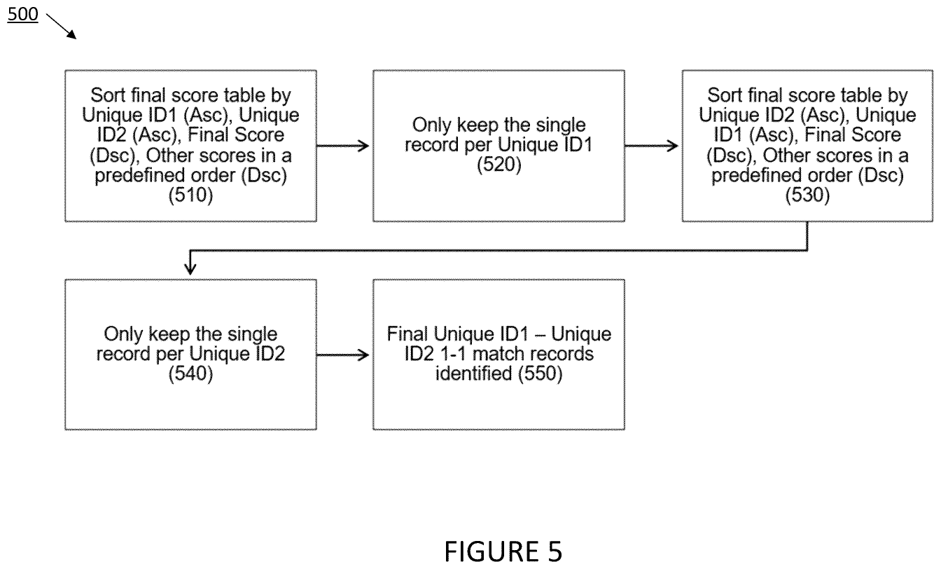

FIG. 5 illustrates a deduplication process 500 according to some embodiments. Depending on the implementation, the process 500 may be in the form of instructions executed by a processor.

In embodiments, each dataset may initially be assigned a Unique ID. However, once two datasets are matched, a Unique ID may be generated for a larger dataset. Unmatched datasets that are added to the matched dataset may join the larger dataset with the same Unique ID for the larger dataset. In some embodiments, the first matched dataset (e.g., the larger dataset) may be assigned a Unique ID1, or a first Unique ID. A second Unique ID, e.g., Unique ID2, may represent any dataset that is not the first matched dataset including another new dataset (e.g., not yet determined to be matched) or an unmatched dataset.

In step 510, a final score table may be sorted by Unique ID1, Unique ID2, final score, and other scores in one or more orders such as ascending or descending. For example, the first row may be retained after sorting the Unique ID1 in ascending order, the Unique ID2 in ascending order, and the final score in descending order.

In step 520, a single record per Unique ID1 may be kept. For example, the topmost sorted record may be kept. The remaining rows may be discarded.

In step 530, the final score table may be sorted, where Unique ID2, Unique ID1, final score, and other scores may be sorted in a predefined order such as ascending or descending. For example, the first row may be retained after sorting the Unique ID2 in ascending order, the Unique ID1 in ascending order, and the final score in descending order. In addition, the final scores for Unique ID2 may be kept.

In step 540, a single record can be retained per Unique ID2. For example, the topmost sorted record may be kept, whereas the remaining records may be discarded.

In step 550, a retained Unique ID1 row may be matched with the retained Unique ID2 row. Duplicate rows may be removed and discarded.

According to some embodiments, with respect to a final score table, duplicated row IDs may be appended into the aggregated unique rows. Accordingly, unique records representing unique individuals in the dataset may be identified. The indexing method described above may then be applied to remove pairs from the table that have the same IDs. For instance, when ID A=ID A, then the pair may be removed from the table. When ID A=ID B, the pair may be retained to generate unique pair IDs.

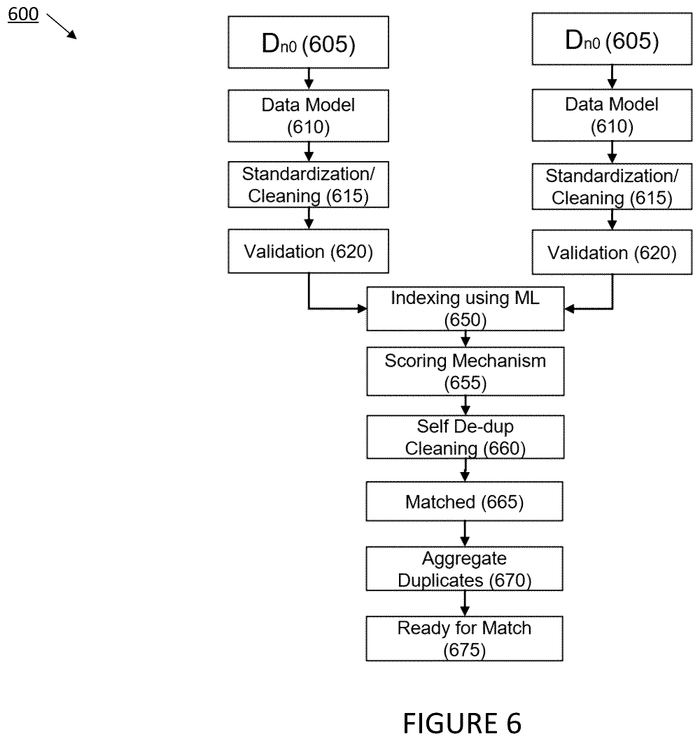

FIG. 6 illustrates a self-deduplication process 600 according to some embodiments. Depending on the implementation, the process 600 may be in the form of instructions executed by a processor.

Process 600 can include matching and scoring a dataset in order to deduplicate the dataset. In step 605, a dataset (Dₙ₀) may be received or accessed from a database stored on a memory as part of a computer network, on a cloud, or a server. In some embodiments, the dataset may be received as a version of a master table or Universal Persons' Dataset.

A preparatory process (i.e., steps 610, 615, and 620) that is similar to process 200 may be conducted on two separate instances of the same dataset. This may include step 610 of parsing the data of the dataset into a data model. The data model may include data fields that track types of record details (e.g., name, email, phone, address, or company). In some embodiments, the data model can be a spreadsheet.

Step 615 may include a standardization/cleaning step similar to step 215 of FIG. 2a. and a validation step 620 similar to step 220 of FIG. 2a.

In step 650, the resulting validated datasets may be indexed. Step 650 can be similar to step 250 of FIG. 2b.

In step 655, the resulting indexed potential pairs may be scored. Step 655 can be similar to step 255 of FIG. 2b.

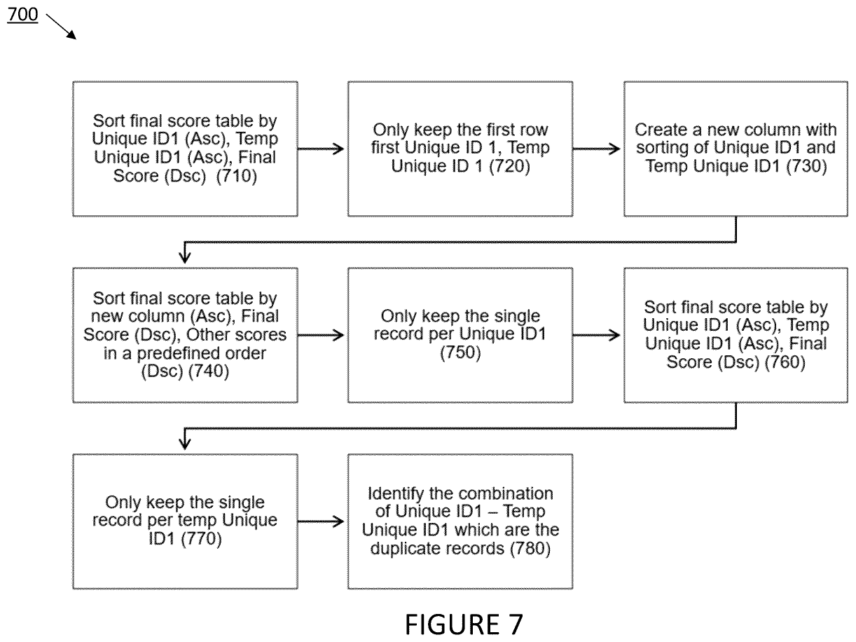

In step 660, the dataset may be self-deduplicated and/or cleaned, which will be discussed with reference to FIG. 7.

In step 665, matched pairs may be identified from the index of potentially matched pairs. Step 665 may be similar to step 265 of FIG. 2b.

In step 670, duplicate records in the dataset may be of aggregated and removed.

In step 675, a master table that is ready for matching to a new table may be output. The master table may have duplicates removed; thus, only unique records remain.

FIG. 7 illustrates a deduplication process 700 according to some embodiments. Depending on the implementation, the process 700 may be in the form of instructions executed by a processor.

In step 710, a final score table by Unique ID1, temporary Unique ID1, and a final score may be sorted in one or more orders, and in step 720, only a first row of the table for Unique ID1 and temporary Unique ID1 may be retained. For example, the first row may be retained after sorting the Unique ID1 in ascending order, the temporary Unique ID1 in ascending order, and the final score in descending order. The temporary unique ID1 may be a copy of Unique ID1. In some embodiments, the sorting can be accomplished on a spreadsheet.

In step 730, a new column may be generated with sorting a Unique ID1 and temporary Unique ID1.

In step 740, a final score table may be sorted by sorting by the new column, a final score, and other scores (e.g., record detail scores) in a predefined order. For example, a single record per Unique ID1 may be retained after sorting the new column from step 730 in ascending order, and the final score in descending order. Other scores (e.g., for record details) can be sorted in a descending order.

In step 750, a single record per Unique ID1 can be retained. For example, the topmost sorted record may be kept, and the remaining records may be discarded.

In step 760, a final score table may be sorted by Unique ID1, a temporary Unique ID1, and a final score. For example, a final score table may be sorted by Unique ID1 in ascending order, temporary Unique ID1 in ascending order, and the final score in descending order.

In step 770, only a first row may be retained based on the temporary Unique ID1. For example, the topmost sorted record may be kept, and the other records may be discarded.

In step 780, final duplicate rows may be identified based on the retained rows. Other duplicate rows may be removed. In some embodiments, a single record can be retained per Unique ID1, and the rest of records and/or scores are deleted.

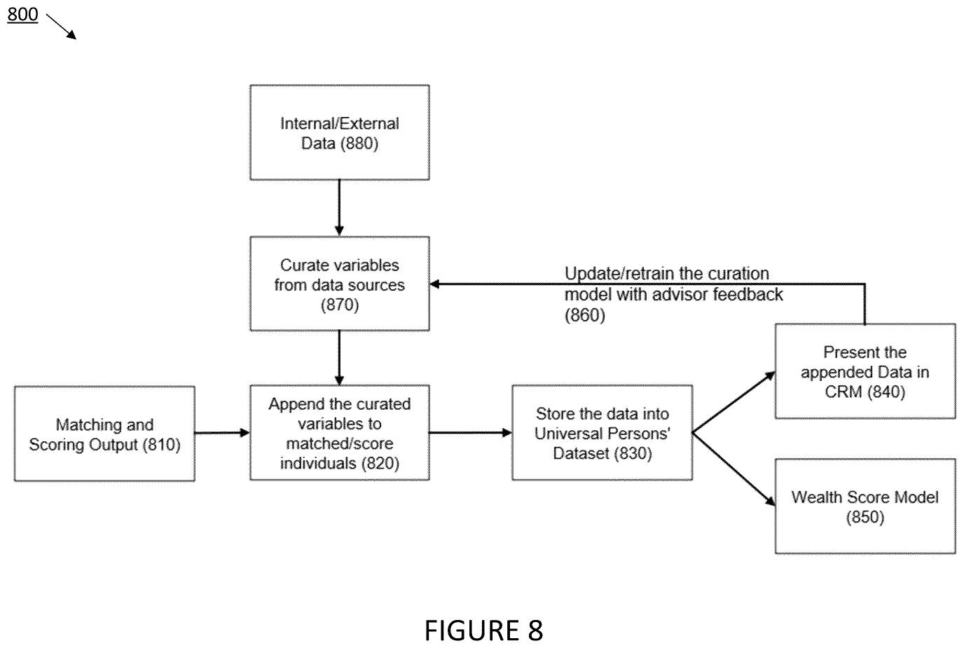

FIG. 8 illustrates a data curation and appending process 800 according to some embodiments. Depending on the implementation, the process 800 may be in the form of instructions executed by a processor.

In step 810, record details may be matched and scored. This may be similar to the matching and scoring process in FIG. 2b.

In step 820, records may be appended to records of an individual. Additional identified variables may be scored according to the scoring process discussed with regard to FIG. 3. In some embodiments, the sorting can be accomplished on a spreadsheet.

In step 820, the record details may be scored to form an aggregate score for the individual. Record details may make up an individual record, and examples of record details are discussed above. In some embodiments, an individual's record may have curated data from step 870 appended to it to enrichen the data.

In step 880, curated data may be received from an internal or external database and may include information such as professional background, education history, wealth source, connections, spending patterns, existing organizational relationships, leisure interests, etc., from internal or external sources.

In step 870, data may be curated from internal and external data sources (e.g., data may be curated from one or more of the datasets used to produce a master dataset, as described above). Curated data may include useful data that is not included in a data model for a master dataset. In some embodiments, a ML curation model can be used to match internal/external data 880 to an existing list of variables to describe an individual. For a single record or for a master dataset, step 870 may include curating data and appending additional record details. In the case of an updated/appended universal data set, the resulting dataset may be saved as a new universal dataset. Additional data may be curated and appended with a machine learning model or manually according to step 820. A ML curation model can be trained on good or bad types of curated data considering various data points as they can relate to a wealth score (e.g., zip code, type of home, etc.). This training data is verified by users. The ML curation model may be provided the one or more online or internal databases to identify curated data to be found and appended to individual records. This way, the classification ML model can identify potential accurate, relevant data quicker and speed up curation.

In step 830, once the data is curated and appended, it may be stored in the universal dataset. In step 840, the appended data may be presented via an interface, such as a customer relationship management interface.

In step 860, users or a training ML may provide feedback or updates to the ML curation model and/or the data model via an interface, such as a customer relationship management interface and/or front-end platform (collectively referred to herein as a “CRM platform”).

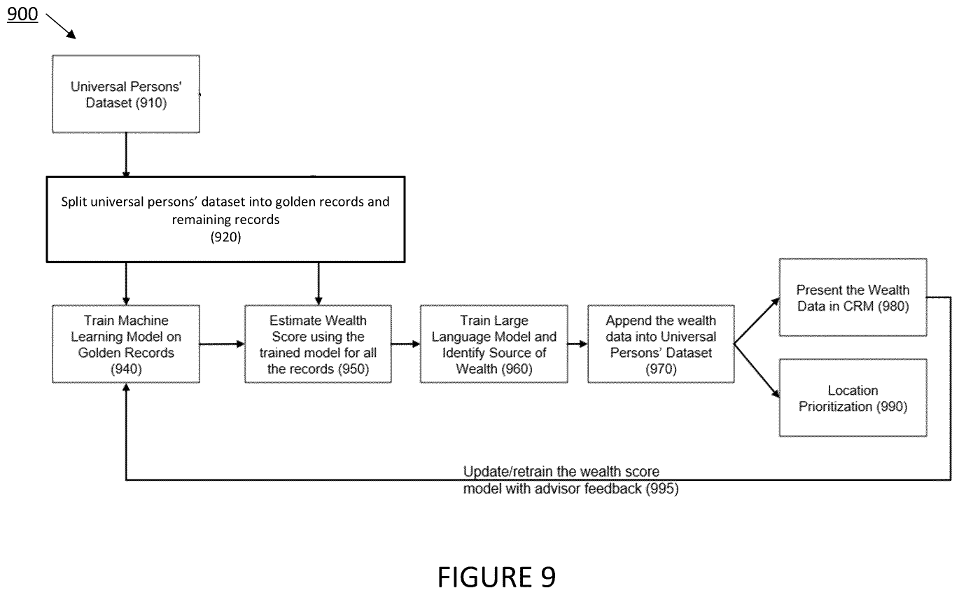

FIG. 9 illustrates a wealth scoring process 900 according to some embodiments. Depending on the implementation, the process 900 may be in the form of instructions executed by a processor.

In step 910, a universal persons' dataset may be accessed or received. In step 920, the universal persons' dataset may be split into golden records and remaining records. A golden data source and golden records may be a universal dataset of records that are business verified to contain detailed and correct information to train a robust wealth scoring ML model. A golden data source may be an internal data source.

In step 940, a machine learning model may be trained with the golden records. For example, a machine learning model (such as a regression and/or classification model) may be trained using golden data sources as a training dataset. These records may be used due to the richness of pertinent data therein. For instance, a golden training dataset may include attributes that may not be present in external data, or in other internal datasets that are not maintained for business purposes related to the predictions a model may be trained to analyze. In other words, a universal dataset may be provided to the trained model, and the model (i.e., a wealth score model) may output predictions of records in the universal dataset that are associated with individuals that meet the threshold wealth requirements.

In step 950, a wealth score may be generated using the trained model from step 940 and the trained model may be applied to the remaining records. Moreover, a universal data set may be provided to a wealth score ML model, and the wealth score ML model may predict records from the universal dataset that are associated with individuals that fall under business aligned wealth requirements. A business aligned wealth requirement may be a threshold net worth and/or an amount of investable assets.

In step 960, output predictions (such as in the form of data records) from a wealth score model may be used as input to a large language model (LLM) to analyze a source of wealth. The input for the LLM may be a professional history (e.g., work history, tenure, company financials), financial indicators (net worth, investable assets, sources of wealth), biography, education, and location details. The output may be wealth scores for each individual record. The LLM may be the same LLM discussed above, or it may be a different LLM.

In step 970, the generated wealth data (e.g., source, wealth score) can be appended to the universal persons' dataset. In particular, the LLM may output a source of wealth for each individual record and the source of wealth may be thereafter appended to the associated record in the universal dataset. In some embodiments, a rules-based algorithm may be used to determine a source of wealth.

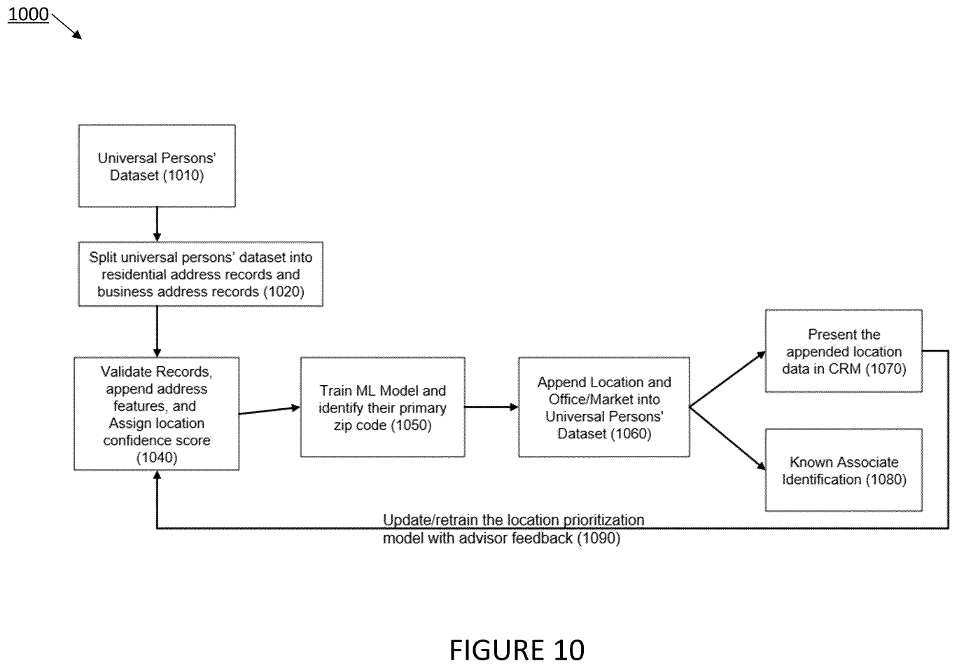

In step 980, some or all results may be displayed in a CRM platform. At step 995, feedback from the CRM platform may be used to update and/or retrain a wealth score model. At step 990, a local prioritization process (e.g., FIG. 10) may be performed to identify certain individuals in the resulting dataset according to one or more parameter such as location and wealth.

FIG. 10 illustrates a local prioritization process 1000 according to some embodiments. Depending on the implementation, the process 1000 may be in the form of instructions executed by a processor.

In step 1010, a universal persons' dataset may be accessed or received.

In step 1020, the universal dataset may be split into different records including residential address records and business address records.

In step 1040, the residential address records and the business address records may be validated against an online repository of addresses and address features can be appended to the records. Address validation may include assignment of a location confidence score to an address record detail.

In step 1050, after validation, a ML model (such as a location prioritization model) may be trained to predict a primary zip code of an individual associated with a record of the universal dataset. The universal dataset may be provided to the ML model, and the model may output a primary zip code associated with a record. In some embodiments, the ML model may use a graph-based model to identify known associate connections of an individual. The ML model can be a ML classification model that is trained on advisor or user validated data and that learns to prioritize identified known associates based on past results and/or successful indicators of association (e.g., similar/same work location, similar/same business interest, similar/same zip code). In step 1060, location and office/market info may be appended to a record based on the output of a location prioritization model.

In step 1070 feedback from a CRM platform may be used to update and/or retrain a location prioritization model.

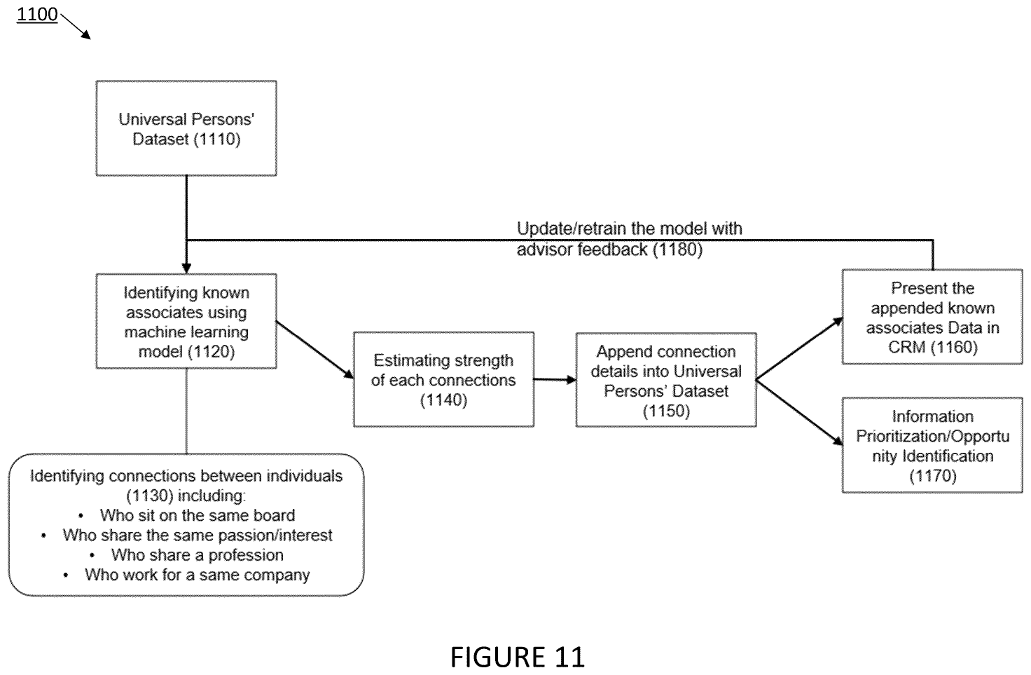

In step 1080, a known associate may be identified (e.g., FIG. 11), for example, based on the highest confidence score, a location, or another parameter consistent with the embodiments discussed herein.

FIG. 11 illustrates a known associate identification process 1100 according to some embodiments. Depending on the implementation, the process 1100 may be in the form of instructions executed by a processor.

In step 1110, a universal persons' dataset may be accessed or received. In step 1120, a universal dataset may be provided to a ML model (such as a clustering ML model or a graph generative model), and, in step 1130, the ML model may output an identification that may include a prediction of associates known to an individual associated with an input record and what the connections between the associates and the individual. In some embodiments, the ML model may use a graph-based model to identify known associate connections of an individual. The ML model can be a ML classification model that is trained on advisor or user validated data/feedback and that learns to prioritize identified known associates based on past results and/or successful indicators of association (e.g., similar/same work location, similar/same business interest, similar/same zip code). In step 1060, location and office/market info may be appended to a record based on the output of a location prioritization model. In step 1140, the ML model may further output a confidence score that estimates a strength of each connection based on the one or more indicators. The ML model can be a ML classification model that is trained on advisor or user validated data/feedback and that learns to score connections of known associates based on past results and/or successful indicators of association (e.g., similar/same work location, similar/same business interest, similar/same zip code). In some embodiments, the ML model can use a rule-based algorithm.

In step 1150, predicted connections of associates may be appended to the associated record of the universal dataset. The output may be in the form of a graph, or in any other suitable format.

In step 1160, feedback from a CRM platform may be used to update and/or retrain a known associate prediction model.

In step 1170, information may be prioritized, or one or more opportunities may be identified. This may be based, for example, on the highest strength connection score, confidence score, a location, or another parameter consistent with the embodiments discussed herein.

In step 1180, the feedback (e.g., success, good connection, no success, bad connection, etc.) may be used to update or retrain the ML model.

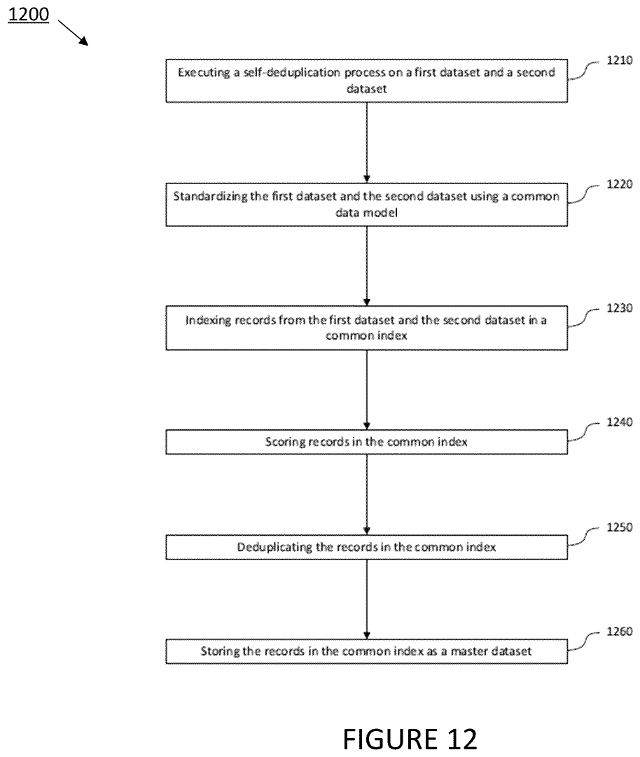

FIG. 12 illustrates a master dataset creation process 1200 according to some embodiments. Depending on the implementation, the process 1200 may be in the form of instructions executed by a processor.

In step 1210, a self-deduplication process may be executed on a first dataset and a second dataset, consistent with disclosed embodiments discussed above (e.g., process 600 of FIG. 6).

In step 1220, the first dataset and the second dataset may be standardized using a common data model. This may be similar to step 210 of FIG. 2a.

In step 1230, records from the first dataset and the second dataset may be indexed in a common index. This may be similar to step 250 of FIG. 2b.

In step 1240, records in the common index may be scored. This may be similar to step 255 of FIG. 2b.

In step 1250, the records in the common index may be deduplicated. This may be similar to step 260 of FIG. 2b, as well as the process 500 of FIG. 5.

In step 1260, records in the common index may be stored as a master dataset. This may be similar to step 275 of FIG. 2b.

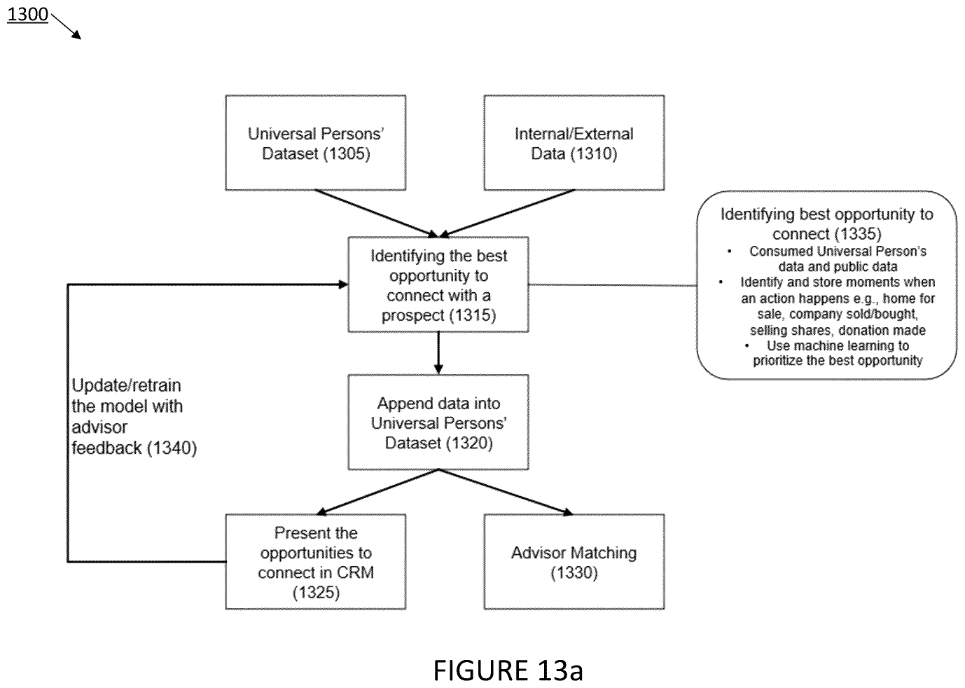

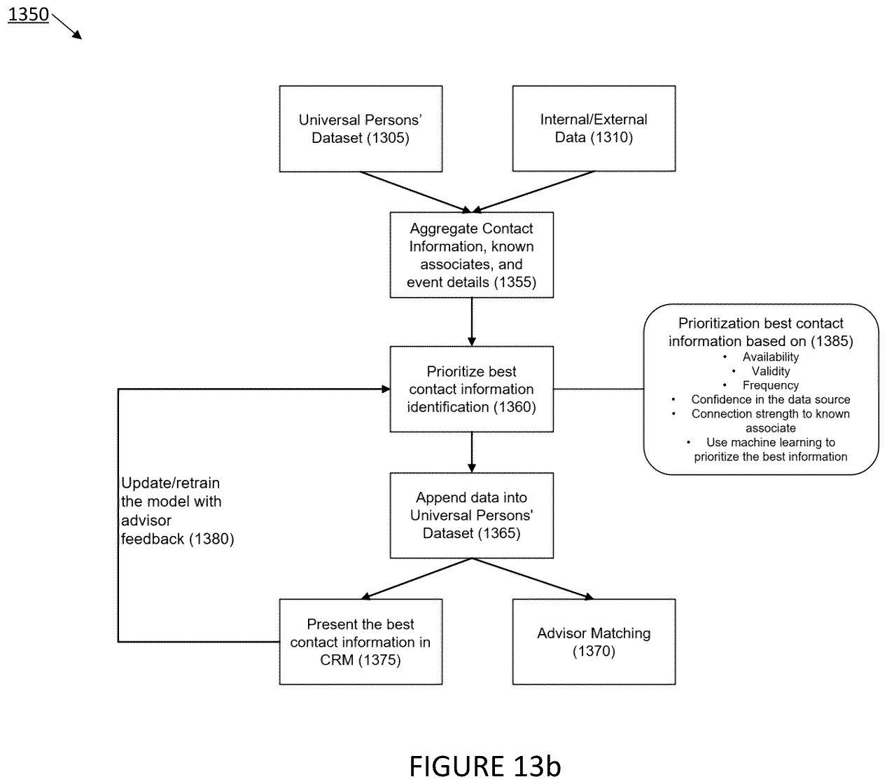

FIG. 13a illustrates a contact timing process 1300 according to some embodiments. Depending on the implementation, the process 1300 may be in the form of instructions executed by a processor.

In step 1305, a universal persons' dataset may be of accessed or received, and in step 1310, internal and/or external data may be accessed or received.

In step 1315, the universal dataset and the internal and/or external dataset may be processed via a rules-based or ML-based process to determine best contract information. In addition, the internal and/or external data may be analyzed in step to determine a triggering event that may identify an opportune time to use the identified contact information. In some embodiments, a ML model can be used for the identification. The triggering event and/or time can be scored. Further, a confidence score can be included for a likelihood of the information being correct. The ML model can be a ML classification model that is trained on advisor or user validated data and that learns to prioritize opportune times based on past results and/or successful indicators of opportune times (e.g., such as the factors listed in step 1335 including a location, a time, a quality of the data source, or an event for the best opportunity to connect). The ML model can also be trained to provide scores for likelihood of success of an opportunity based on previous results. As illustrated in box 1335, in embodiments, the output of step 1315 may include opportunities to connect and a potential best opportunity to connect.

In step 1320, the contact timing identified in step 1310 may appended to associated records in a universal dataset.

In step 1325, the resulting list of opportunities to make contact may be presented, for example, in a CRM platform.

In step 1330, an advisor may be matched, for example, based on the most likely triggering event, the most opportune time, confidence score, a location, or another parameter consistent with the embodiments discussed herein.

In step 1340, the feedback (e.g., success, good connection, no success, bad connection, etc.) can be used to update or retrain the ML model.

FIG. 13b illustrates a contact timing process 1350 according to some embodiments. Depending on the implementation, the process 1350 may be in the form of instructions executed by a processor.

In step 1305, a universal persons' dataset may be of accessed or received, and in step 1310, internal and/or external data may be accessed or received.

In step 1355, a universal dataset may be processed via a rules-based or ML-based process to determine best contract information. In addition, the internal and/or external data may be analyzed in step 1355 to determine a contact information, known associates, and event details.

In step 1360, contact information, known associates, and/or event details for an individual may be prioritized. For example, a ML model may be used for the prioritization of best contact information identification. In addition, the triggering event and/or time can be scored, and a confidence score for a likelihood of the information being correct may be included. The ML model can be a ML classification model that is trained on advisor or user validated data and that learns to prioritize opportune times based on past results and/or successful indicators of opportune times (e.g., such as the factors listed in step 1385 including an availability, a validity, a frequency, or a quality of the data source for the best communication method). The ML model can also be trained to provide scores for likelihood of success of a communication method based on previous results.

As illustrated in box 1385, an output can include contact information including relevant information including availability, validity, frequency, confidence in the data source, connection strength to known associates, and local prioritization consistent with disclosed embodiments.

In step 1365, information identified in a contact method process may be appended to associated records in a universal dataset, and in step 1375, the resulting list of opportunities may be presented, for example, in a CRM platform.

In step 1370, an advisor may be matched based, for example, on the most likely contact method, the most likely available time, a confidence score, a connection strength, a frequency in the data, or another parameter consistent with the embodiments discussed herein.

In step 1380, the feedback (e.g., success, good connection, no success, bad connection, etc.) can be used to update or retrain the ML model.

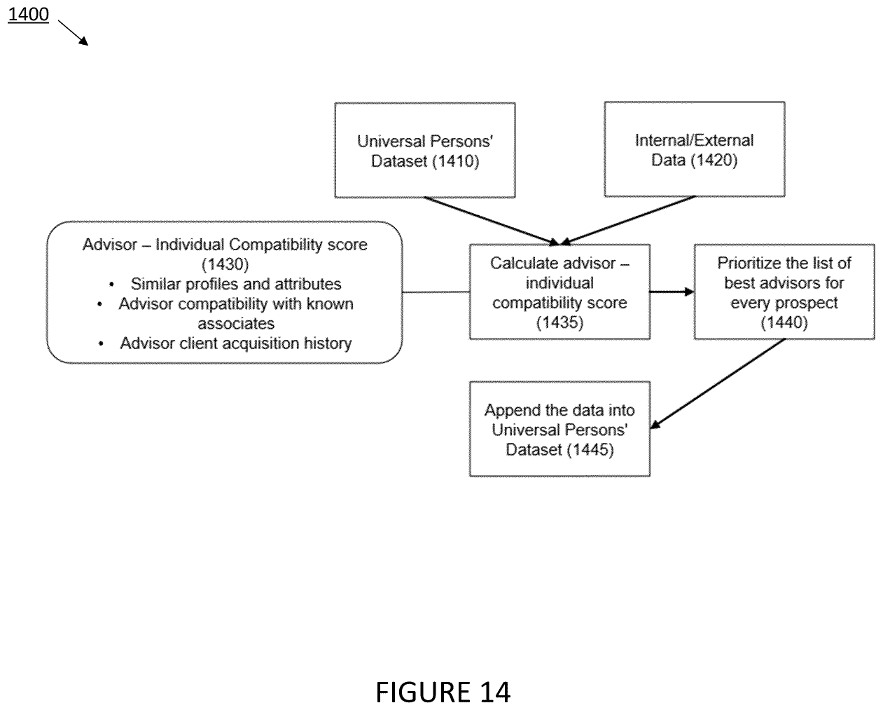

FIG. 14 illustrates an advisor matching process 1400 according to some embodiments. Depending on the implementation, the process 1400 may be in the form of instructions executed by a processor.

In step 1405 a universal persons' dataset may be accessed or received, and in step 1420, internal and/or external data may be accessed or received.

In step 1435, an advisor-individual compatibility score may be generated. For example, ML may be used based on historical records to generate the compatibility score. Moreover, the internal and/or external data may be analyzed to determine compatibility based on, for example, a comparison of profiles and/or attributes of an individual an advisor, an advisor compatibility with a known associate of the individual, and/or an advisor client acquisition history.

As illustrated in box the output of step 1435 may include an advisor compatibility score for an individual including one or more scores or information related to the criteria used for selection consistent with disclosed embodiments.

In step 1440, based on an advisor compatibility score, a prioritized list of advisors may be generated for an analyzed record of a universal dataset. At step 1445, the list of advisors may be appended to a record in the universal dataset.

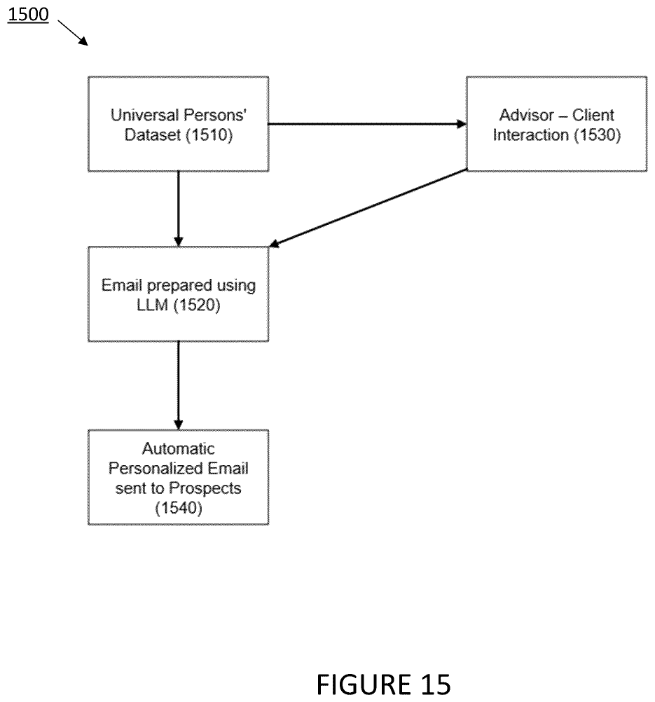

FIG. 15 illustrates an automated contact process 1500 according to some embodiments. Depending on the implementation, the process 1500 may be in the form of instructions executed by a processor.

In step 1505, a universal persons' dataset may be accessed or received, and in step 1530, an advisor interaction may also be received.

In step 1520, a relevant record from a universal dataset and the advisor-client interaction may be used as input to an LLM. This may be the same or a different LLM from those described above. The LLM may predict a choice of words or topics to use in a communication. For example, the LLM may be prompted with the relevant record and the advisor-client interaction to generate a personalized email.

In step 1540, the LLM may be configured to output a personalized email to an individual associated with the relevant record or dataset and/or the advisor-client interaction or event that occurred. In some embodiments, the LLM can determine a time for the email to be send out based on the individual record, and one or more of the best moment and method of communication to connect (see FIGS. 13a, 13b). The generation may include inserting relevant information into a template to send to prospects.

In accordance with embodiments disclosed herein, a universal dataset and ML models used to build and append data to a universal dataset may be configured as part of an iterative training and retraining environment. Data developed from ML models and rules-based processes discussed herein may be aggregated and appended to the universal dataset and/or used to retrain the models and processes. User input can be used in the aggregation of feedback. New data from successful cases can also be used for the retraining of models.

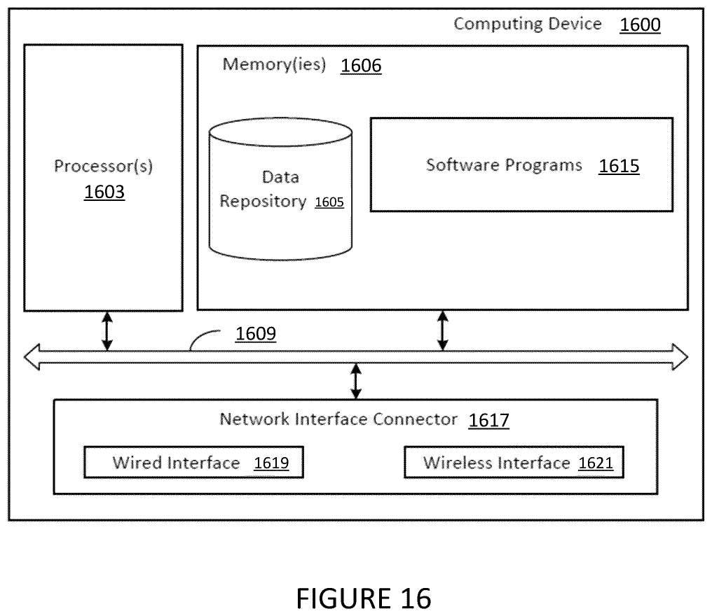

FIG. 16 is a block diagram of a computing device for implementing certain embodiments of the present disclosure. FIG. 16 depicts exemplary computing device 1600. Computing device 1600 may represent hardware that executes the logic that drives the various system components described herein. For example, system components such as a ML model engine, an interface, various database engines and database servers, and other computer applications and logic may include, and/or execute on, components and configurations like, or similar to, computing device 1600.

Computing device 1600 includes a processor 1603 coupled to a memory 1606. Memory 1606 may include volatile memory and/or persistent memory. The processor 1603 executes computer-executable program code stored in memory 1606, such as software programs 1615. Software programs 1615 may include one or more of the logical steps disclosed herein as a programmatic instruction, which can be executed by processor 1603. Memory 1606 may also include data repository 1605, which may be nonvolatile memory for data persistence. The processor 1603 and the memory 1606 may be coupled by a bus 1609. In some examples, the bus 1609 may also be coupled to one or more network interface connectors 1617, such as wired network interface 1619, and/or wireless network interface 1621. Computing device 1600 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one embodiment, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method executed by a processor of one or more computers, the method comprising:
executing a self-deduplication process on a first dataset and a second dataset;
standardizing the first dataset and the second dataset using a common data model;
indexing records from the first dataset and the second dataset in a common index;
scoring records in the common index;
deduplicating the records in the common index; and
storing the records in the common index as a master dataset.

2. The method of claim 1, further comprising pairing partial matches from the first dataset and the second dataset.

3. The method of claim 1, further comprising calculating a frequency for one or more of a phone number, an address, and a company name for each dataset, and retaining matching pairs based on the frequency being less than a threshold.

4. The method of claim 1, further comprising appending each potential matching pair to the master dataset based on a frequency less than a threshold of a type of information.

5. The method of claim 1, wherein scoring records comprises generating a score with a point value for a matched pair from each dataset, and retaining matching pairs based on the point value at least meeting a threshold amount.

6. The method of claim 1, further comprising generating a final score table with the indexed records and the scores, wherein deduplicating comprises sorting the final score table in ascending order a generated first unique identification of the common index, sorting in descending order a generated second unique identification of the common index, sorting a score in a descending order, and retaining only a first row of the table per first unique identification.

7. The method of claim 6, wherein deduplicating further comprises sorting the final score table in ascending order a generated first unique identification of the common index, sorting in ascending order a generated second unique identification of the common index, sorting a score in a descending order, and retaining only final scores for the generated second unique identification.

8. A system comprising one or more processors and one or more storage devices storing instructions that when executed by one or more processors, cause the processor to:
execute a self-deduplication process on a first dataset and a second dataset;
standardize the first dataset and the second dataset using a common data model;
index records from the first dataset and the second dataset in a common index;
score records in the common index;
deduplicate the records in the common index; and
store the records in the common index as a master dataset.

9. The system of claim 8, further comprising pairing partial matches from the first dataset and the second dataset.

10. The system of claim 8, further comprising calculating a frequency for one or more of a phone number, an address, and a company name for each dataset, and retaining matching pairs based on the frequency being less than a threshold.

11. The system of claim 8, further comprising appending each potential matching pair to the master dataset based on a frequency less than a threshold of a type of information.

12. The system of claim 8, wherein scoring records comprises generating a score with a point value for a matched pair from each dataset, and retaining matching pairs based on the point value at least meeting a threshold amount.

13. The system of claim 8, further comprising generating a final score table with the indexed records and the scores, wherein matching comprises sorting the final score table in ascending order a generated first unique identification of the common index, sorting in descending order a generated second unique identification of the common index, sorting a score in a descending order, and retaining only a first row of the table per first unique identification.

14. The system of claim 13, wherein matching further comprises sorting the final score table in ascending order the generated second unique identification of the common index, sorting in ascending order the generated first unique identification of the common index, sorting a score in a descending order, and retaining only final scores for the generated second unique identification.

15. A method executed by a processor of one or more computers, the method comprising:
matching a first dataset from an internal dataset from a memory on a computer network with a second dataset from an external dataset and forming a larger dataset from the first dataset and the second dataset;
deduplicating the larger dataset;
identifying a subset from the larger dataset using a parameter;
determining associated features of the subset;
prioritizing the associated features based on a detail of the first or second datasets;
identifying known features in a local database based on the prioritized associated features and estimating a strength of connection of the known features and the prioritized associated features;
selecting an internal database based on the known features, the associated features, and a score of the associated and known features as a match with the internal database; and
generating an interface comprising a message based on the known features, the internal database, and the associated features.

16. The method of claim 15, further comprising pairing partial matches from the first dataset and the second dataset.

17. The method of claim 15, further comprising calculating a frequency for one or more of a phone number, an address, and a company name for each dataset, and retaining matching pairs based on the frequency being less than a threshold.

18. The method of claim 15, further comprising generating a master dataset from the deduplication and appending each potential matching pair to the master dataset based on a frequency less than a threshold of a type of information.

19. The method of claim 15, wherein scoring records comprises generating a score with a point value for a matched pair from each dataset, and retaining matching pairs based on the point value at least meeting a threshold amount.

20. The method of claim 15, further comprising index records from the first dataset and the second dataset in a common index; generating a master dataset from the common index; generating a final score table with the indexed records and the scores, wherein matching comprises sorting the final score table in ascending order a generated first unique identification of the common index, sorting in descending order a generated second unique identification of the common index, sorting a score in a descending order, and retaining only a first row of the table per first unique identification.
